(19) United States
(12) Patent Application Publication
(10) Pub. No.: US 2025/0145091 A1
(43) Pub. Date: May 8, 2025

(54) REAR CARGO TRAY SYSTEMS AND RELATED METHODS

(71) Applicant: South East Manufacturing Inc., Wilson, NC (US)

(72) Inventors: Zachary Hall, Lucama, NC (US); Timothy Martin, New Bern, NC (US); Nicholas Martin, New Bern, NC (US)

(21) Appl. No.: 18/942,191

(22) Filed: Nov. 8, 2024

Related U.S. Application Data
(60) Provisional application No. 63/597,288, filed on Nov. 8, 2023.

(51) Int. Cl. B60R 11/06; B60R 11/00

(52) U.S. Cl. CPC B60R 11/06; B60R 2011/0036; B60R 2011/005; B60R 2011/0082

(57) ABSTRACT

Rear cargo tray systems to provide extra storage within a vehicle and related methods are provided herein. A rear cargo tray system for rotatable securement to an interior portion of a vehicle can include a tray body and first and second tray brackets that provide support surfaces on which the tray body can rest. The rear cargo system can comprise first and second hinges secured to the tray body and the respective first and second tray brackets and first and second gas springs anchored to the respective first and second tray brackets with piston arms that can be secured to the tray body. Further, the rear cargo system can comprise at least one latch secured to the tray body distal from the first and second hinges configured to engage a locking plate on one of the first or second tray brackets.

### RELATED APPLICATIONS

The presently disclosed subject matter claims the benefit of U.S. Provisional Patent Application Ser. No. 63/597,288, filed Nov. 8, 2023, the disclosure of which is incorporated herein by reference in its entirety.

### TECHNICAL FIELD

The present subject matter relates to rear cargo tray systems to provide storage within a vehicle when needed and methods related to the rear cargo tray systems. In particular, the present subject matter relates to rear cargo tray systems that can be installed in the rear cargo bay of a sports utility vehicle that can be rotated between an up position and a down position to provide different storage capabilities.

### BACKGROUND

Sports Utility Vehicles (“SUVs”) have gained tremendous popularity over the past several years and have quickly become one of the most common body types you will see on the road. A big reason why SUVs are so popular is due to versatility and cargo space. Smaller SUVs are great for commuters or small families that need a bit more room than a sedan or hatchback can provide. Many SUVs offer even more space inside the cabin, with a large range of sizes available, including compact and full-size mode. SUVs also tend to offer a wide range of drivetrain options. Front-wheel drive is common as an affordable and fuel-efficient option for drivers. All-wheel drive is a popular choice among SUV drivers in that it helps them handle the vehicle easier in slippery road conditions. Some SUVs offer rear-wheel drive. For drivers how enjoy outdoor activities, many SUVs offer four-wheel drive for enhanced performance.

Some SUVs, such as Jeeps® and the new Ford Broncos®, have been designed to be highly customizable with modular designs that permit companies to provide aftermarket parts and additional components that add features no offered on the respective vehicles by the manufacturer. For example, off-road modular SUV designs offer a user-friendly platform that can be stripped to its base structure so that alternate doors, fenders, and grille can be added in one afternoon. The following day, a whole new SUV can be reconfigured for another new adventure with a different body and roof setup. Such SUVs were designed and engineered from a clean slate to make off-road customization easy, quick, and attainable for all enthusiasts with a wide variety of interests and skill levels.

Some vehicles, such as Jeeps® and Ford Broncos®, have rear cargo areas behind the back seat that provides space for storage and hauling of a wide variety of cargo. While the rear cargo area can generally provide more cargo space than a trunk of a car, the shape of the space with a taller height component can lead to unused space depending on the items being hauled in the cargo space. Stationary trays have been provided to provide an extra surface space to places items on while leaving a larger cargo bay below. Sometimes, however, the taller spaced provided be the full cargo space is needed for the hauling of some items. In such instances, the stationary trays must be removed and stored.

As such, a need exists for rear cargo tray systems to provide extra storage surface within a vehicle when needed to meet the needs of the owner or user of the vehicle.

### SUMMARY

The present subject matter relates to rear cargo tray systems to provide extra storage surface within a vehicle when needed and methods related to the rear cargo tray systems. In particular, the present subject matter relates to rear cargo tray systems that can be installed in the rear cargo bay of a sport utility vehicle that can be rotated between an up position and a down position to provide different storage capabilities. Methods related to the use and assembly of the rear cargo tray systems disclosed herein are also provided.

Thus, it is an object of the presently disclosed subject matter to provide rear cargo tray systems to provide extra storage surface within a vehicle when needed as well as methods related thereto. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIGS. 1A, 1B, and 1C illustrate perspective views of a rear cargo area of a vehicle having an embodiment of a rear cargo tray system according to present subject matter;

FIG. 2 illustrates a perspective view of an embodiment of a tray body of rear cargo tray system according to the present subject matter;

FIGS. 3A and 3B illustrate respective right and left top, side perspective views of an embodiment of a rear cargo tray system in a down, or closed, position according to the present subject matter ready for installation in a rear cargo area of a vehicle;

FIG. 4A illustrates a side perspective view of an embodiment of a rear cargo tray system in an up, or open, position according to the present subject matter ready for installation in a rear cargo area of a vehicle;

FIG. 4B illustrates a side perspective view of an embodiment of a rear cargo tray system in a down, or closed, position according to FIG. 4A;

FIG. 5A illustrates an exploded perspective view of an embodiment of parts of a rear cargo tray system according to the present subject matter; and

FIG. 5B illustrates an exploded perspective view of the embodiment of a portion of a rear cargo tray system according to FIG. 5A.

Repeat use of reference characters in the present specification and drawings is intended to represent the seam or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, top, bottom, etc., may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer, or section. Thus, a first feature, element, component, region, layer, or section discussed below could be termed a second feature, element, component, region, layer, or section without departing from the teachings of the disclosure herein.

Similarly, when a feature or element is being described in the present disclosure as “on” or “over” another feature or element, it is to be understood that the features or elements can either be directly contacting each other or have another feature or element between them, unless expressly stated to the contrary. Thus, these terms are simply describing the relative position of the features or elements to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

The present subject matter relates to rear cargo tray systems to provide storage within a vehicle when needed and methods related to the rear cargo tray systems. For example, a rear cargo tray system can be provided that can be installed in the rear cargo bay of a sports utility vehicle that can reside in a down, horizontal position to provide a top surface on which items can be placed, and can be rotated to an up, vertical position to provide a large storage space in the rear cargo bay. The rear cargo tray systems when installed in the rear cargo bay of a sports utility vehicle can be rotated between an up position and a down position to provide different storage capabilities.

Thus, the present disclosure is related to rear cargo tray systems to provide different storage capabilities within a vehicle when needed by being rotatable between an up position and a down position. For example, a rear cargo tray system for rotatable securement to an interior portion of a vehicle can comprise a tray body can include a tray bed that forms a first tray bed surface and an opposing second tray bed surface and first and second end walls that can extend upward from ends of the tray bed above the first tray bed surface as well as first and second side walls that can extend upward from sides of the tray bed above the first tray bed surface. The rear cargo tray system can also comprise a first tray bracket and a second tray bracket. Each of the first and second tray brackets can comprise a support surface on which a portion of the second tray surface of the tray bed can reside when in a down position. Each of the first and second tray brackets can include a hinge plate that extends transverse to the support surface and a lock plate that also extends transverse to the support surface. Additionally, rear cargo tray system can comprise a first hinge and a second hinge. The first hinge can be secure to the first end wall of the tray body and rotatably secured to the hinge plate on the first tray bracket. The second hinge can be secured to the second end wall of the tray body and rotatably secured to the hinge plate on the second tray bracket. The rear cargo tray system can also comprise a first gas spring and a second gas spring that can be secured to the tray body as well as to the respective first and second tray brackets. For example, the first gas spring can comprise an anchor end secured to an inside surface of the hinge plate on the first tray bracket and a piston arm that is extendable and retractable from a barrel of the first gas spring having a distal arm end securable to the first end wall of the tray body. Similarly, the second gas spring can comprise an anchor end secured to an inside surface of the hinge plate on the second tray bracket and a piston arm that is extendable and retractable from a barrel of the second gas spring having a distal arm end securable to the first end wall of the tray body. Further, the rear cargo tray system can comprise first and second latches. The first latch can be secured on a side of the first end wall of the tray body distal from the hinge secured to the first end wall. The second latch can be secured on a side of the second end wall of the tray body distal from the hinge secured to the second end wall. The first latch can be configured to engage a latch arm extending from the first lock plate of the first tray bracket, while the second latch can be configured to engage a latch arm extending from the second lock plate of the second tray bracket. Additional features of the rear cargo systems disclosed herein are provided with reference to the figures below.

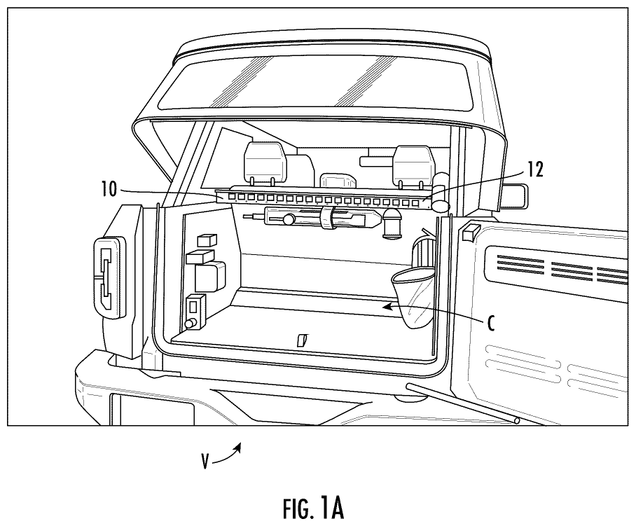

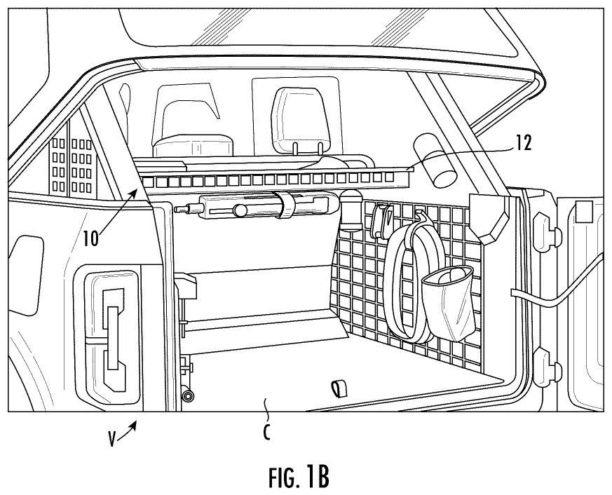

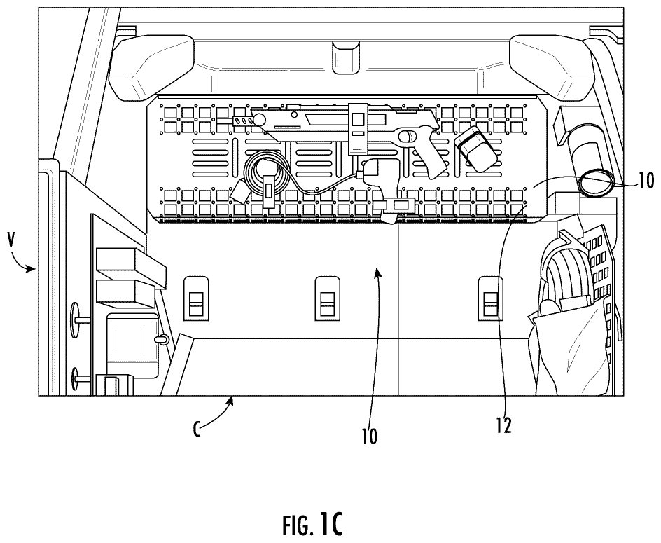

Referring to FIGS. 1A-1C, images of a vehicle, in particular, an SUV V, such as a Ford Bronco®, showing a rear cargo area, or bay, with a rear cargo tray system, generally, 10 installed therein. The rear cargo tray system 10 can be installed in an interior portion of the SUV V in the rear cargo area C behind the back seat BS of the SUV V. For example, the rear cargo tray system 10 can be secured to interior side walls of the SUV V. The rear cargo tray system 10 can comprise a tray body 12 that include opposing tray bed surfaces on which items can be placed or secured. When in use, the tray body 12 can reside in a down, or closed, position to as shown in FIGS. 1A and 1B to a provide a first tray bed surface on which items can be placed and/or secured. When a taller and deeper cargo space is needed, the tray body 12 can be rotated to an up, or open, position as shown in FIG. 1C. In this manner, a versatile storage system can be installed in an SUV V that can easily provide different storage capabilities within a vehicle when needed by have a tray can be easily rotated between an up position and a down position.

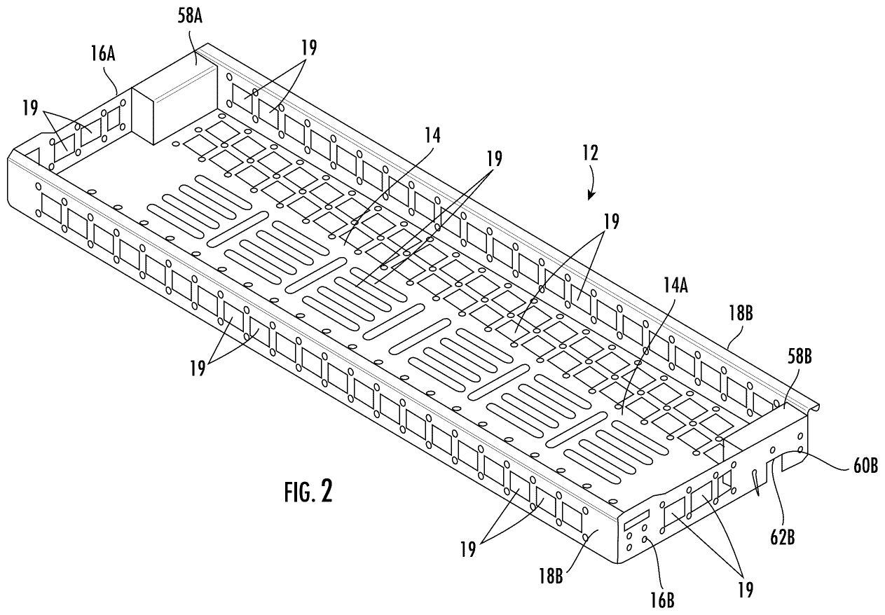

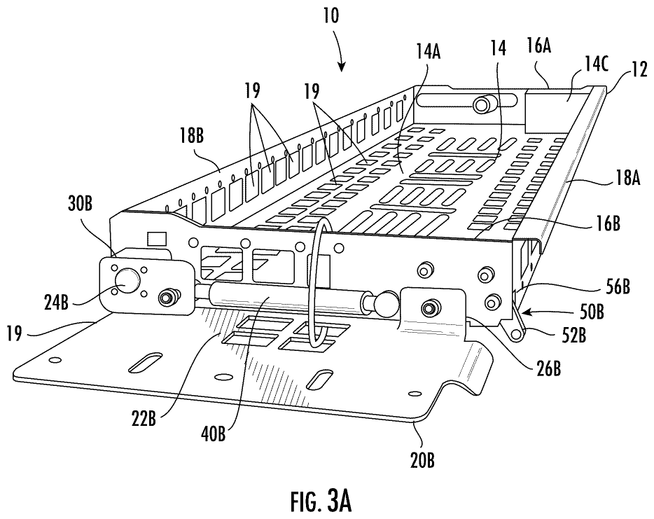

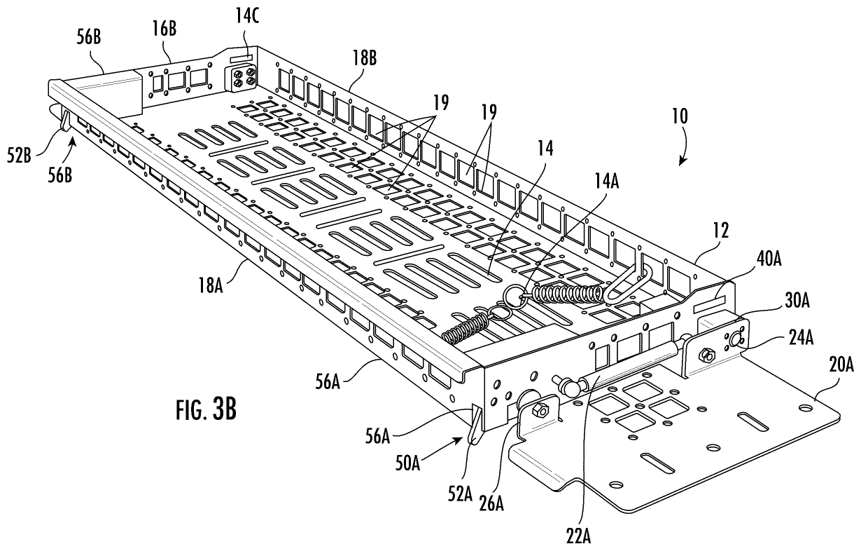

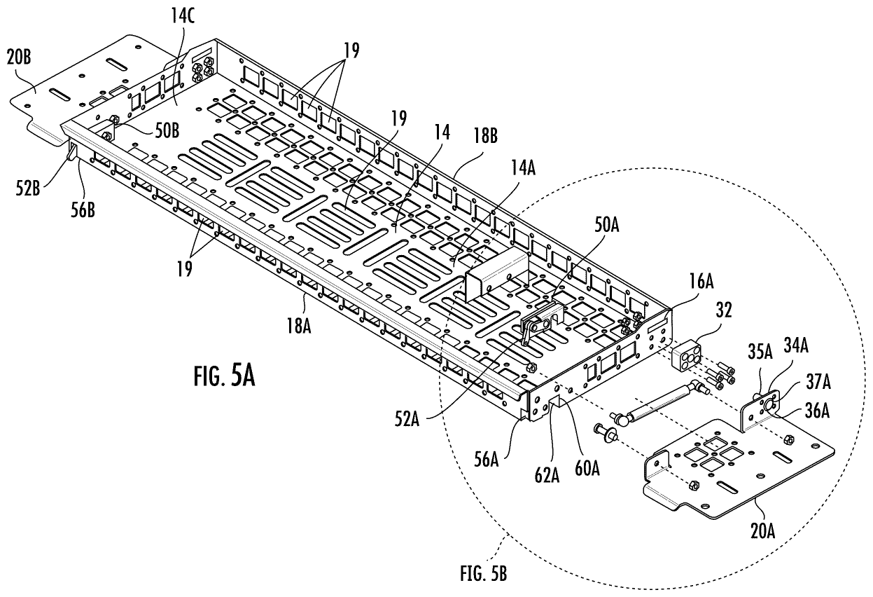

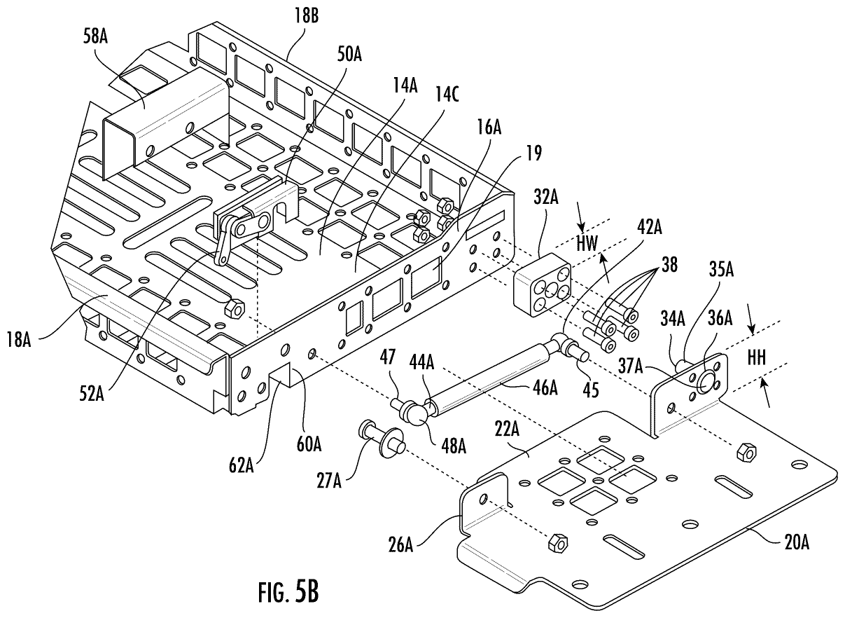

Referring to FIGS. 2A-5B, the rear cargo tray system 10 can comprise the tray body 12, a first tray bracket 20A and a second tray bracket 20B, a first hinge 30A and a second hinge 30B that can be secured to the tray body 12 and the respective first and second tray bracket 20A, 20B. Additionally, rear cargo tray system 10 can comprise a first gas spring 40A and a second gas spring 40B that can be secured to the tray body 12 as well as to the respective first and second tray brackets 20A, 20B. Further, the rear cargo tray system 10 can also comprise a first latch 50A and a second latch 50B. The first and second latches 50A, 50B can be secured to the tray body 12 distal from the first and second hinges 30A, 30B. The first and second latches 50A, 50B can be used to lock, or securely hold the tray body 12 in the down position with the first and second latches 50A, 50B being releasable to allow the tray body 12 to be moved to the up position where the first and second gas springs 40A, 40B can hold the tray body 12 in the up position until it is pulled back to the down position.

Referring to FIGS. 2A, 4A-4B and 5A-5B, the tray body 12 can comprise a tray bed 14 having a first tray bed surface 14A and an opposing second tray bed surface 14B. The tray body 12 can comprise a first end wall 16A and a second end wall 16B that can extend upward from ends 14C of the tray bed 14 above the first tray bed surface 14A. Additionally, the tray body 12 can comprise a first side wall 18A and a second side wall 18B that can extend upward from sides 14D of the tray bed 14 above the first tray bed surface 14A. The first and second side walls 18A, 18B can extend between the first and second end walls 16A, 16B. The tray body 12 can comprise Modular Lightweight Load-carrying Equipment (MOLLE) apertures 19 in the tray bed 14. These MOLLE apertures 19 can provide easy securement apertures to attached items to either the first tray bed surface 14A or the opposing second tray bed surface 14B so that the items stay securely on the first tray bed surface 14A or the opposing second tray bed surface 14B whether the tray body 12 is in the up position or the down position. In some embodiments, MOLLE apertures 19 can also be the first and second end walls 16A, 16B, or the first and second side walls 18A, 18B.

The rear cargo tray system can also comprise a first tray bracket 20A and a second tray bracket 20B. Each of the first and second tray brackets 20A, 20B can comprise a support surface 22A, 22B on which a portion of the second tray surface 14B of the tray bed 14 can reside when in a down position. Each of the first and second tray brackets 20A, 20B can comprise a hinge plate 24A, 24B that extends transverse to the respective support surface 22A, 22B to which the respective first and second hinges 30A, 30B can be attached or rotatably secured. In some embodiments, the hinge plates 24A, 24B can be portions the respective first and second tray brackets. The hinge plates 24A, 24B can be bend at a right angle to the respective support surfaces 22A, 242B. Additionally, each of the first and second tray brackets 20A, 20B can comprise a lock plate 26A, 26B that also extends transverse to the support surface 22A, 22B. Each of the lock plates 26A, 26B can have a portion that can be engaged by the respective first and second latches 50A, 50B. Similar to the hinge plates 24A, 24B, the lock plates 26A, 26B can be portions the first and second tray brackets 20A, 20B, and the lock plates 26A, 26B can bend at a right angle to the respective support surfaces.

As stated above, rear cargo tray system 10 can comprise a first hinge 30A and a second hinge 30A. The first hinge 30A can be secure to the first end wall 16A of the tray body 12 and rotatably secured to the hinge plate 24A on the first tray bracket 20A. The second hinge 30B can be secured to the second end wall 16B of the tray body 12 and rotatably secured to the hinge plate 24B on the second tray bracket 20B. The first and second hinges 30A, 30B permit the tray body 12 to rotate about axis that passes through the first and second hinges 30A, 30B. When in the rear cargo tray system 10 is stalled, the portion of the rear cargo tray system 10 where the first and second hinges 30A, 30B reside can be closer to the back seats of the vehicle the portion of the rear cargo tray system 10 where the first and second latches 50A, 50B reside.

In some embodiments, the first and second hinge plates 24A, 24B can have a height HH such that the first and second hinge plates 24A, 24B can extend above and below the anchor ends 42A, 42B of the respective first and second gas springs 40A, 40B to provide external protection the respective anchor ends 42A, 42B. Each of the first and second hinges 30A, 30B can have a width HW that creates a separation space between the first and second hinge plates 24A, 24B and the first and second end walls 16A, 16B of the tray body 12, respectively. The separation spaces providing an operation space between the respective first and second hinge plates 24A, 24B and the respective first and second end walls 24A, 24B of the tray body 12 in which the respective first and second gas springs 40A, 40B and the anchor ends 42A, 42B of the respective first and second gas springs 40A, 40B can rotate as the tray body 12 is movable between an upright position and a down position. Each of the first and second hinges 30A, 30B comprise a hinge block 32A, 32B securable to the respective first and second end walls 16A, 16B of the tray body 12 and a hinge pin 34A, 34B that be inserted through a hinge pin aperture 36A, 36B in the respective first and second hinge plates 24A, 24B and engageable with the hinge block 32A, 32B such that each of the hinge blocks 32A, 32B is rotatable. In some embodiments, each of the hinge blocks 32A, 32B can be rotatable about its respective hinge pin 34A, 34B. In some embodiments, each of the hinge pins 34A, 34B can be rotatable within the respective hinge pin aperture 36A, 36B of the first and second hinge plates 24A, 24B. The hinge blocks 32A, 32B of the first and second hinges 30A, 30B ca be secured to the respective first and second end walls 16A, 16B by fasteners 38. Each of the hinge pins 34A, 34B can comprise a body 35 and a head 37 on a first distal end of the body 35. When installed in the hinge block 32A, 32B, the hinge pins 34A, 34B can extend out from the hinge blocks 32A, 32B of the first and second hinges 30A, 30B when the hinge pins 34A, 34B have engaged the hinge blocks 32A, 32B such that portions of the bodies 35 of the hinge pins 35 can extend out from the hinge blocks 32A, 32B between ends of the hinge blocks 32A, 32B and the heads 37 of the hinge pins 34A, 34B.

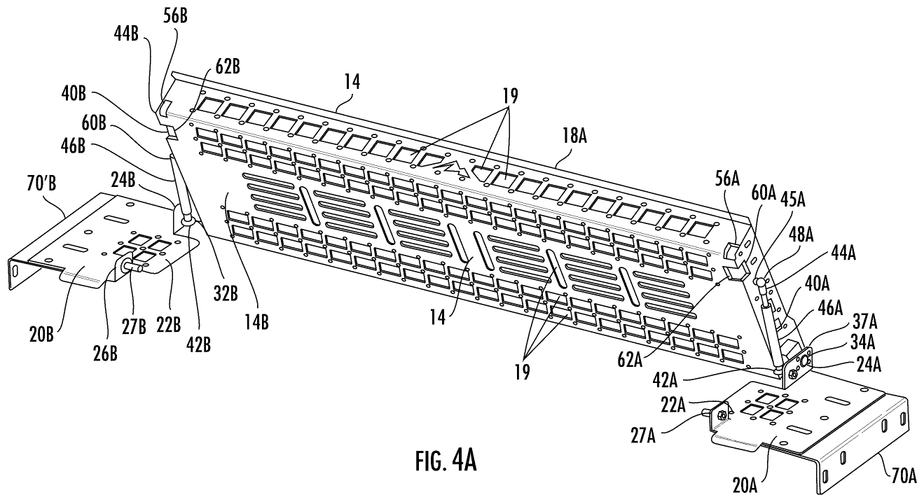

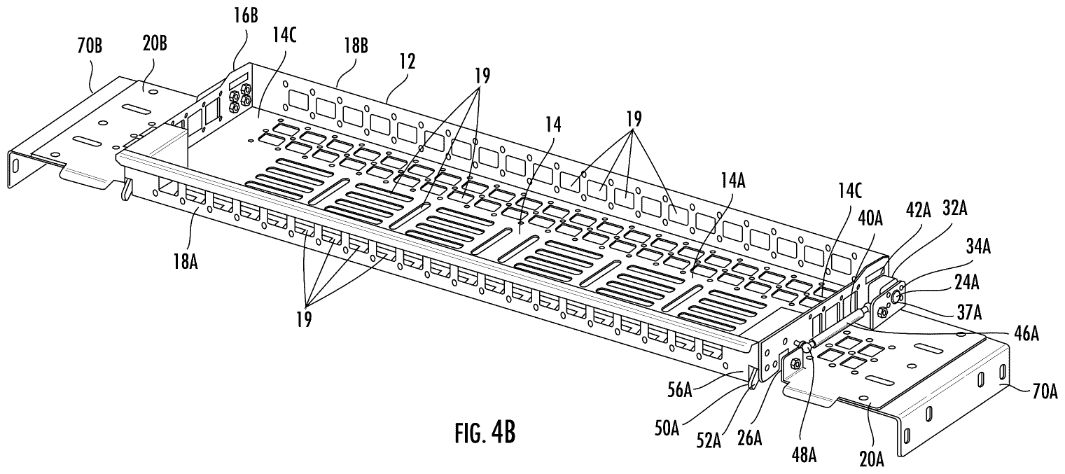

Additionally, as stated above, the rear cargo tray system 10 can also comprise a first gas spring 40A and a second gas spring 40B that can be secured to the tray body 12 as well as to the respective first and second tray brackets 20A, 20B. When the tray body 12 is moved to the up position as shown in FIG. 4A, the first and second gas springs 40A, 40B can hold the tray body 12 in the up position. For example, the first and second gas springs 40A, 40B can auto open at about 42° and can have an opening angle of about 70°. Additionally, the first and second gas springs 40A, 40B can have a minimum hold open effort of about 20 Newtons to facilitate holding the tray body 12 in the up, or open, position.

The first gas spring 40A can comprise an anchor end 42A secured to an inside surface of the hinge plate 24A on the first tray bracket 20A and a piston arm 44A that is extendable and retractable from a barrel 46A of the first gas spring 40A. The piston arm 44A can comprise a distal arm end 48A that can be secured to the first end wall 16A of the tray body 12. Similarly, the second gas spring 40B can comprise an anchor end 42B secured to an inside surface of the hinge plate 24B on the second tray bracket and a piston arm 44B that is extendable and retractable from a barrel 46B of the second gas spring 40B. The piston arm 44A can also have a distal arm end 48B that can be secured to the second end wall 16B of the tray body 12. The anchor end 42A of the first gas spring 40A can have a connector 45 thereon. Similarly, the anchor end 42B of the second gas spring 40B can have a connector 45 thereon. The connectors 45 on the anchor ends 42A, 42B of the respective first and second gas springs 40A, 40B can extend in a respective first direction transverse to the respective gas springs 40A, 40B to allow the first and second gas springs 40A, 40B to be secured to the hinge plates 24A, 24B. The piston arm 44A of the first gas spring 40A can have a connector 47 thereon. Similarly, the piston arm 44B of the second gas spring 40B can have a connector 47 thereon. The connectors 47 on the piston arms 44A, 44B of the respective first and second gas springs 40A, 40B extend in a respective second direction transverse to the respective gas springs 40A, 40B with the respective second direction being in the opposite direction from the respective first direction. The connectors 47 on the piston arms 44A, 44B can allow the first and second gas springs 40A, 40B to be secured to the respective end walls 16A, 16B.

Further, the rear cargo tray system 10 can comprise first and second latches 50A, 50B. The first latch 50A can be secured on a side of the first end wall 16A of the tray body 12 distal from the hinge 30A secured to the first end wall 16A. Similarly, the second latch 50B can be secured on a side of the second end wall 16B of the tray body 12 distal from the hinge 30A secured to the second end wall 16B. Each of the lock plates 26A, 26B of the first and second tray brackets first and second gas springs 20A, 20B can comprise a latch arm 27A, 27B extending outward from the respective lock plate 26A, 26B toward the tray body 12. The first latch 50A can be configured to engage the latch arm 27A extending from the first lock plate 26A of the first tray bracket 20A, while the second latch 50B can be configured to engage a latch arm 27B extending from the second lock plate 26B of the second tray bracket. To facilitate the locking of the tray body 12 in the down, or closed, position, each of the first and second end walls 16A, 16B of the tray body 12 can comprise a locking channel 60A, 60B on the respective end portion distal from the respective first and second hinges 40A, 40B. Additionally, the tray bed 14 of the tray body 12 can comprise corresponding channels 62A, 62B aligned with the locking channels 60A, 60B in the respective first and second end walls 16A, 16B of the tray body 12. The corresponding channels 62A, 62B aligned with the locking channels 60A, 60B are configured for receiving the latch arms 27A, 27B of the lock plates 26A, 26B of the respective first and second tray brackets 20A, 20B. In particular, the first and second latches 50A, 50B are respectively aligned with the locking channels 60A, 60B of the first and second end walls 16A, 16B and the corresponding channels 62A, 62B of the tray bed 14 for receiving the latch arms 27A, 27B of the lock plates 26A, 26B of the respective first and second tray brackets 20A, 20B.

In some embodiments, each of the first and second latches 50A, 50B comprise a rotary push-to-close latch with a release lever 52A, 52B that that can extend outward from a body 52A, 52B of the respective latch 50A, 50B. Each of the release levers 52A, 52B can be moved to release the respective latch 50A, 50B if the lock mechanism in the latch 50A, 50B has been push to a closed position. The first side wall 18A can comprise release channels 56A, 56B therein in which release lever 52A, 52B of the respective first and second latches 50A, 50B can extend for releasing the latches 50A, 50B from the respective latch arms 27A, 27B. The rear cargo tray system 10 can further comprise first and second latch housings 58A, 508B. The first and second latch housings 58A, 58B can be secured to the respective first and second end walls 16A, 16B of the tray body 12 to protect the first and second latches 50A, 50B.

Facilitate securement of the rear cargo tray system 10 within different sized and configured vehicles and to provide adjustability, the rear cargo tray system 10 can also comprise first and second base brackets 70A, 70B that can be secured to the interior of a vehicle. In use, the first and second base brackets 70A, 70B can be secured to opposing interior side of a vehicle. Once the first base bracket 70A has been secured to a first interior side wall of the vehicle, the first tray bracket 20A can be secured to the first base bracket 70A. Similarly, once the second base bracket 70B has been secured to a second interior side wall of the vehicle, the second tray bracket 20B can be secured to the second base bracket 70B. The first and second base brackets 70A, 70B and the first and second tray brackets 20A, 20B can have slots therein that can be aligned to further facilitate the adjustability of the rear cargo tray system 10.

Thus, as disclosure hereinabove, an embodiment of a rear cargo tray system for rotatable installation in an interior portion of a vehicle can be provided. The rear cargo tray system can comprise a tray body and a first tray bracket and a second tray bracket. Each of the first and second tray brackets can comprise a support surface on which a portion of the tray body resides when in a down position. A hinge plate can extend transverse to the support surface and a lock plate can extend transverse to the support surface. The rear cargo tray system can comprise a first hinge secured to a first end of the tray body and rotatably secured to the hinge plate on the first tray bracket and a second hinge secured to a second end of the tray body and rotatably secured to the hinge plate on the second tray bracket. Additionally, the rear cargo tray system can comprise a first gas spring having an anchor end secured to the hinge plate on the first tray bracket and a piston arm securable to the first end of the tray body and a second gas spring having an anchor end secured to the hinge plate on the second tray bracket and a piston arm securable to the second end of the tray body. Further, the rear cargo tray system can comprise at least one latch secured on the tray body distal from at least one of the first hinge or the second hinge. The at least one latch can be configured to engage at least one of the first lock plate or the second lock plate.

In some such embodiments, the tray body comprises a tray bed, first and second end walls, and first and second side walls that extend between the first and second end walls. The tray bed can form a first tray bed surface and an opposing second tray bed surface with the first and second end walls extending upward from ends of the tray bed above the first tray bed surface. In such embodiments, the first hinge can be secured to the first end wall of the tray body and rotatably secured to the hinge plate on the first tray bracket. Similarly, the second hinge can be secured to the second end wall of the tray body and rotatably secured to the hinge plate on the second tray bracket. In some such embodiments, the anchor end of the first gas spring can be secured to an inside surface of the hinge plate on the first tray bracket, while the piston arm can be extendable and retractable from a barrel of the first gas spring and the piston arm having a distal end that is secured to the first end wall of the tray body. Similarly, the anchor end of the second gas spring can be secured to an inside surface of the hinge plate on the second tray bracket. The piston arm can be extendable and retractable from a barrel of the second gas spring and the piston arm having a distal end that is secured to the second end wall of the tray body. In some such embodiments, the at least one latch can comprise a first latch is secured on a side of the first end wall of the tray body distal from the first hinge secured to the first end wall and a second latch secured on a side of the second end wall of the tray body distal from the second hinge secured to the second end wall, the first latch configured to engage a latch arm extending from the first lock plate and the second latch configured to engage a latch arm extending from the second lock plate.

In some such embodiments, each of the first and second end walls of the tray body can comprise a locking channel on a respective end portion distal from the respective first and second hinges. Additionally, the tray bed can comprise corresponding channels aligned with the locking channels in the respective first and second end walls of the tray body. The aligned channels are configured for receiving the latch arms of the lock plates of the respective first and second tray brackets. The first and second latches can be respectively aligned with the locking channels of the first and second end walls and the corresponding channels of the tray beds for receiving the latch arms of the lock plates of the respective first and second tray brackets. In some such embodiments, the each of the first and second hinges can comprise a hinge block securable to the respective first and second end walls of the tray body and a hinge pin that is insertable through a hinge pin aperture in the respective first and second hinge plates and engageable with the hinge block such that the hinge block is rotatable.

In some such embodiments, the rear cargo tray system can additionally comprise first and second base brackets that are securable to an interior of the vehicle. The first base bracket can be secured to a first interior side wall of the vehicle. Then, the first tray bracket can be secured to the first base bracket. Similarly, and the second base bracket can be secured to a second interior side wall of the vehicle with the second tray bracket hen being securable to the second base bracket.

Similarly, as disclosed herein, in other embodiments, a rear cargo tray system for rotatable installation in an interior portion of a vehicle can be provided. The rear cargo tray system can comprise a tray body comprising a tray bed, first and second end walls, and first and second side walls that extend between the first and second end walls. The tray bed forms a first tray bed surface and an opposing second tray bed surface with the first and second end walls extending upward from ends of the tray bed above the first tray bed surface. The rear cargo tray system can also comprise a first tray bracket and a second tray bracket. Each of the first and second tray brackets comprising a support surface on which a portion of the second tray surface is restable. Additionally, each of the first and second tray brackets can have a hinge plate that extends transverse to the support surface and a lock plate that extends transverse to the support surface. The rear cargo tray system can comprise a first hinge that can be secured to the first end wall of the tray body and be rotatably secured to the hinge plate on the first tray bracket. Similarly, a second hinge can be secured to the second end wall of the tray body and be rotatably secured to the hinge plate on the second tray bracket. Additionally, the rear cargo tray system can comprise a first gas spring having an anchor end secured to an inside surface of the hinge plate on the first tray bracket. A piston arm of the first gas spring that is extendable and retractable from a barrel of the first gas spring can have a distal end, which serves as a distal end of the first gas spring as well, securable to the first end wall of the tray body. Similarly, the rear cargo tray system can comprise a second gas spring having an anchor end secured to an inside surface of the hinge plate on the second tray bracket. A piston arm of the second gas spring that is extendable and retractable from a barrel of the second gas spring can have a distal end, which serves as a distal end of the second gas spring as well, that is securable to the second end wall of the tray body. Further, the rear cargo tray system can comprise first and second latches. The first latch can be secured on a side of the first end wall of the tray body distal from the first hinge secured to the first end wall. The second latch can be secured on a side of the second end wall of the tray body distal from the second hinge secured to the second end wall. The first latch can be configured to engage a latch arm extending from the first lock plate, while the second latch can be configured to engage a latch arm extending from the second lock plate.

In some such embodiments, the rear cargo tray system can comprise first and second base brackets that can be secured to an interior of the vehicle. The first base bracket can be secured to a first interior side wall of the vehicle with the first tray bracket being securable to the first base bracket. Similarly, the second base bracket can be secured to a second interior side wall of the vehicle with the second tray bracket being securable to the second base bracket.

In some such embodiments, the tray body can comprise MOLLE apertures on at least one of the tray bed, the first and second end walls, or the first and second side walls.

In some such embodiments, each of the first and second end walls of the tray body can comprise a locking channel on a respective end portion distal from the respective first and second hinges. Similarly, the tray bed can comprise corresponding channels aligned with the locking channels in the respective first and second end walls of the tray body configured for receiving the latch arms of the lock plates of the respective first and second tray brackets. The first and second latches can be respectively aligned with the locking channels of the first and second end walls and the corresponding channels of the tray beds for receiving the latch arms of the lock plates of the respective first and second tray brackets. Additionally, the first side wall can comprise release channels therein in which release levers of the respective first and second latches extend for releasing the first and second latches from the respective latch arms. The rear cargo tray system can comprise first and second latch housings that can be secured to the respective first and second end walls of the tray body to protect the first and second latches.

In some such embodiments, connectors on the anchor ends of the respective first and second gas springs can extend in a first direction transverse to the respective first and second gas springs and connectors on the piston arms of the respective first and second gas springs extend in a second direction transverse to the respective gas springs with the second direction being in an opposite direction from the first direction.

In some such embodiments, the respective hinge plates of the first and second tray brackets can be integral, unitary portions of the respective first and second tray brackets. Such respective hinge plates of the first and second tray brackets can bend at a right angle to the respective support surfaces. Similarly, the lock plates of the first and second tray brackets can be portions of the first and second tray brackets. Such respective lock plates of the first and second tray brackets can bend at a right angle to the respective support surfaces.

In some such embodiments, the hinge plates of the first and second tray brackets can each have a height such that each respective hinge plates extends above and below the anchor ends of the respective first and second gas springs to provide external protection the respective anchor ends. Additionally, each of the first and second hinges can have a width that creates a separation space between the hinge plates of the first and second tray brackets and the first and second end walls of the tray body, respectively. The separation spaces can provide an operation space between the respective first and second hinge plates and the respective first and second end walls of the tray body in which the respective first and second gas springs and the anchor ends of the respective first and second gas springs can rotate as the tray body is movable between an upright position and a down position. In some such embodiments, each of the first and second hinges can comprise a hinge block securable to the respective first and second end walls of the tray body and a hinge pin that is insertable through a hinge pin aperture in the respective first and second hinge plates and engageable with the hinge block such that the hinge block is rotatable. For example, each of the hinge blocks can be rotatable about its respective hinge pin. In particularly, each of the hinge pins can be rotated within the respective hinge pin aperture of the first and second hinge plates. The hinge blocks of the first and second hinges can be secured to the respective first and second end walls by fasteners. In practice, each of the hinge pins can comprise a body and a head on a first distal end of the body. The hinge pins can extend out from the hinge blocks of the first and second hinges when the hinge pins have engaged the hinge blocks such that portions of the bodies extend out from the hinge blocks between ends of the hinge blocks and the heads of the hinge pins.

In some such embodiments, each of the first and second latches can comprise a rotary push-to-close latch with a release lever that extends outward from a body of the latch that is movable to release the latch if a lock mechanism in the latch has been push to a closed position.

Further, as disclosure hereinabove, a number of different methods of assembly and installation are provided herein. For example, a method of installing a rear cargo tray system in an interior portion of a vehicle can be provided. The method can comprise providing a tray body and a first tray bracket and a second tray bracket and securing each of the first and second tray brackets to an interior of a vehicle. A first hinge can be secured to a first end of the tray body and a hinge plate on the first tray bracket. Similarly, a second hinge can be secured to a second end of the tray body and a hinge plate on the second tray bracket, such that the tray body is rotatable relative to the respective first and second tray bracket. The method can comprise securing an anchor end of a first gas spring to the hinge plate on the first tray bracket and a piston arm of the first gas spring to the first end of the tray body. Similarly, the method can comprise securing an anchor end of a second gas spring to the hinge plate on the second tray bracket and a piston arm of the first gas spring to the second end of the tray body. The method can further comprise securing at least one latch to the tray body such that the at least one latch is configured to engage at least one of a first lock plate on the first tray bracket or a second lock plate on the second tray bracket. In some such embodiments of the method, a first base bracket and a second base bracket can be provided. In such embodiments, the step of securing the securing the first and second tray brackets to an interior of a vehicle can comprise securing each of the first and second base brackets to the interior of the vehicle and securing the first tray bracket to the first base bracket and the second tray bracket to the second base bracket.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

What is claimed is:

1. A rear cargo tray system for rotatable installation in an interior portion of a vehicle, the rear cargo tray system comprising:
a tray body;
a first tray bracket and a second tray bracket, each of the first and second tray brackets comprising a support surface on which a portion of the tray body resides when in a down position, a hinge plate that extends transverse to the support surface and a lock plate that extends transverse to the support surface;
a first hinge secured to a first end of the tray body and rotatably secured to the hinge plate on the first tray bracket and a second hinge secured to a second end of the tray body and rotatably secured to the hinge plate on the second tray bracket;
a first gas spring having an anchor end secured to the hinge plate on the first tray bracket and a piston arm securable to the first end of the tray body and a second gas spring having an anchor end secured to the hinge plate on the second tray bracket and a piston arm securable to the second end of the tray body; and
at least one latch secured on the tray body distal from at least one of the first hinge or the second hinge, the at least one latch being configured to engage at least one of the first lock plate or the second lock plate.

2. The rear cargo tray system according to claim 1, wherein the tray body comprises a tray bed and first and second end walls, the tray bed forms a first tray bed surface and an opposing second tray bed surface with the first and second end walls extending upward from ends of the tray bed above the first tray bed surface.

3. The rear cargo tray system according to claim 2, wherein the first hinge is secured to the first end wall of the tray body and rotatably secured to the hinge plate on the first tray bracket and the second hinge secured to the second end wall of the tray body and rotatably secured to the hinge plate on the second tray bracket.

4. The rear cargo tray system according to claim 2, wherein the anchor end of the first gas spring is secured to an inside surface of the hinge plate on the first tray bracket and the piston arm is extendable and retractable from a barrel of the first gas spring and the piston arm having a distal end that is secured to the first end wall of the tray body; and
the anchor end of the second gas spring is secured to an inside surface of the hinge plate on the second tray bracket and the piston arm is extendable and retractable from a barrel of the second gas spring and the piston arm having a distal end that is secured to the second end wall of the tray body.

5. The rear cargo tray system according to claim 2, wherein the at least one latch comprises a first latch is secured on a side of the first end wall of the tray body distal from the first hinge secured to the first end wall and a second latch secured on a side of the second end wall of the tray body distal from the second hinge secured to the second end wall, the first latch configured to engage a latch arm extending from the first lock plate and the second latch configured to engage a latch arm extending from the second lock plate.

6. The rear cargo tray system according to claim 2, wherein the tray body further comprises first and second side walls that extend between the first and second end walls.

7. The rear cargo tray system according to claim 6, wherein each of the first and second end walls of the tray body comprise a locking channel on a respective end portion distal from the respective first and second hinges and the tray bed comprises corresponding channels aligned with the locking channels in the respective first and second end walls of the tray body configured for receiving the latch arms of the lock plates of the respective first and second tray brackets.

8. The rear cargo tray system according to claim 7, wherein the first and second latches are respectively aligned with the locking channels of the first and second end walls and the corresponding channels of the tray bed for receiving the latch arms of the lock plates of the respective first and second tray brackets.

9. The rear cargo tray system according to claim 2, wherein each of the first and second hinges comprise a hinge block securable to the respective first and second end walls of the tray body and a hinge pin that is insertable through a hinge pin aperture in the respective first and second hinge plates and engageable with the hinge block such that the hinge block is rotatable.

10. The rear cargo tray system according to claim 1, further comprising first and second base brackets that are securable to an interior of the vehicle, the first base bracket being securable to a first interior side wall of the vehicle and the first tray bracket being securable to the first base bracket and the second base bracket securable to a second interior side wall of the vehicle and the second tray bracket being securable to the second base bracket.

11. A rear cargo tray system for rotatable installation in an interior portion of a vehicle, the rear cargo tray system comprising:
a tray body comprising a tray bed, first and second end walls, and first and second side walls that extend between the first and second end walls, the tray bed forming a first tray bed surface and an opposing second tray bed surface with the first and second end walls extending upward from ends of the tray bed above the first tray bed surface;
a first tray bracket and a second tray bracket, each of the first and second tray brackets comprising a support surface on which a portion of the second tray surface is restable, each of the first and second tray brackets having a hinge plate that extends transverse to the support surface and a lock plate that extends transverse to the support surface;
a first hinge secured to the first end wall of the tray body and rotatably secured to the hinge plate on the first tray bracket and a second hinge secured to the second end wall of the tray body and rotatably secured to the hinge plate on the second tray bracket;
a first gas spring having an anchor end secured to an inside surface of the hinge plate on the first tray bracket and a piston arm that is extendable and retractable from a barrel of the first gas spring having a distal end securable to the first end wall of the tray body;
a second gas spring having an anchor end secured to an inside surface of the hinge plate on the second tray bracket and a piston arm that is extendable and retractable from a barrel of the second gas spring having a distal end securable to the second end wall of the tray body; and
a first latch secured on a side of the first end wall of the tray body distal from the first hinge secured to the first end wall and a second latch secured on a side of the second end wall of the tray body distal from the second hinge secured to the second end wall, the first latch configured to engage a latch arm extending from the lock plate on the first tray bracket and the second latch configured to engage a latch arm extending from the lock plate on the second tray bracket.

12. The rear cargo tray system according to claim 11, further comprising first and second base brackets that are securable to an interior of the vehicle, the first base bracket being securable to a first interior side wall of the vehicle and the first tray bracket being securable to the first base bracket and the second base bracket securable to a second interior side wall of the vehicle and the second tray bracket being securable to the second base bracket.

13. The rear cargo tray system according to claim 11, wherein each of the first and second end walls of the tray body comprise a locking channel on a respective end portion distal from the respective first and second hinges and the tray bed comprises corresponding channels aligned with the locking channels in the respective first and second end walls of the tray body configured for receiving the latch arms of the lock plates of the respective first and second tray brackets.

14. The rear cargo tray system according to claim 13, wherein the first and second latches are respectively aligned with the locking channels of the first and second end walls and the corresponding channels of the tray beds for receiving the latch arms of the lock plates of the respective first and second tray brackets.

15. The rear cargo tray system according to claim 11, wherein connectors on the anchor ends of the respective first and second gas springs extend in a first direction transverse to the respective first and second gas springs and connectors on the piston arms of the respective first and second gas springs extend in a second direction transverse to the respective first and second gas springs with the second direction being in an opposite direction from the first direction.

16. The rear cargo tray system according to claim 11, wherein the hinge plates of the first and second tray brackets have a height such that the respective hinge plates extends above and below the anchor ends of the respective first and second gas springs to provide external protection for the respective anchor ends.

17. The rear cargo tray system according to claim 11, wherein each of the first and second hinges have a width that creates a separation space between the hinge plates of the first and second tray brackets and the first and second end walls of the tray body, respectively, and the separation spaces providing an operation space between the respective first and second hinge plates and the respective first and second end walls of the tray body in which the respective first and second gas springs and the anchor ends of the respective first and second gas springs can rotate as the tray body is movable between an upright position and a down position.

18. The rear cargo tray system according to claim 17, wherein each of the first and second hinges comprise a hinge block securable to the respective first and second end walls of the tray body and a hinge pin that is insertable through a hinge pin aperture in the respective first and second hinge plates and engageable with the hinge block such that the hinge block is rotatable.

19. A method of installing a rear cargo tray system in an interior portion of a vehicle, the method comprising:
providing a tray body and a first tray bracket and a second tray bracket;
securing each of the first and second tray brackets to an interior of the vehicle;
securing a first hinge to a first end of the tray body and a hinge plate on the first tray bracket and a second hinge to a second end of the tray body and a hinge plate on the second tray bracket, such that the tray body is rotatable relative to the respective first and second tray bracket;
securing an anchor end of a first gas spring to the hinge plate on the first tray bracket and a piston arm of the first gas spring to the first end of the tray body;
securing an anchor end of a second gas spring to the hinge plate on the second tray bracket and a piston arm of the first gas spring to the second end of the tray body; and
securing at least one latch to the tray body such that the at least one latch is configured to engage at least one of a lock plate of the first tray bracket or a lock plate of the second tray bracket.

20. The method according to claim 19, further comprising:
providing a first base bracket and a second base bracket; and
wherein the step of securing the first and second tray brackets to an interior of a vehicle comprises:
securing each of the first and second base brackets to the interior of the vehicle; and
securing the first tray bracket to the first base bracket and the second tray bracket to the second base bracket.
